(19) United States
(12) Patent Application Publication
(10) Pub. No.: US 2022/0159980 A1
(43) Pub. Date: May 26, 2022

(54) SYSTEM AND METHOD FOR SMOKE TAINT ELIMINATION IN FRUITS AND VEGETABLES

(71) Applicants: Christian DeBlasio, Belmont, CA (US); Grant Still Shatto, III, Castro Valley, CA (US); Richard W Wilson, San Diego, CA (US); Tyler Quinn Murphy, Vallejo, CA (US)

(72) Inventors: Christian DeBlasio, Belmont, CA (US); Grant Still Shatto, III, Castro Valley, CA (US); Richard W Wilson, San Diego, CA (US); Tyler Quinn Murphy, Vallejo, CA (US)

(73) Assignee: Purfresh Clean Inc., Hayward, CA (US)

(21) Appl. No.: 17/529,057

(22) Filed: Nov. 17, 2021

Related U.S. Application Data
(60) Provisional application No. 63/117,412, filed on Nov. 23, 2020.

(51) Int. Cl. A23B 7/152

(52) U.S. Cl. CPC A23B 7/152; A23V 2002/00

(57) ABSTRACT

A method and system are described for reducing smoke taint in fruits and vegetables using limited ozone exposures ranging from 1 ppm-hour to 5000 ppm-hour of said fruits and vegetables.

### FIELD OF THE DISCLOSURE

The disclosure broadly relates to a system and method for smoke taint elimination in fruits and vegetables, in particular a system and method for eliminating smoke odors from fruits and vegetables, most particularly wine grapes, table grapes, stone fruit, berries, apples and pears, using gaseous ozone (trioxygen or O₃) to destroy compounds originating from biomass fires.

### BACKGROUND OF THE DISCLOSURE

Ozone is an extremely reactive molecule and this reactivity has allowed its use in different applications for the preservation of food substances. United States Patent Application 20080159910 by Dick, P. H. et al teaches a shipping container for transporting perishable products while refrigerating and inhibiting spoilage in the products, said shipping container comprising: an enclosure adapted for shipping; gas circulating means for producing a circulating stream of oxygen-containing gas within the enclosure; a refrigeration unit for refrigerating the oxygen-containing gas; an ozone generator; an ozone injector for injecting ozone gas inside the enclosure and into the gas stream; sensing means for determining an ozone concentration in the gas stream; and; a controller for controlling the ozone injecting means to achieve a target ozone concentration in the circulating stream. It should be noted that the purpose of ozone in this application was to destroy microorganisms and to decompose the ethylene that fresh products emit, in order to deter fruit ripening in an enclosed container.

A similar use for ozone was described by Bellincontro et al (Australian Journal of Grape and Wine Research, 2017) in their investigation using ozone to eliminate the use of sulfur dioxide added at the start of the wine-grape fermentation. The postharvest ozonation fumigation overnight of Petit Verdot grapes with 3 mg/liter (1400 ppm) eliminated the need for sulfur dioxide, significantly decreased the microbial count and increased the anthocyanin concentrations in the finished wines.

Ozone fumigation can have other effects beyond microbe elimination. Segade (Food Research International, 2019), for example, has shown changes in stilbenes, including trans-resveratrol and its derivatives, during ozone exposure of 60 ul/L for 48 hours of “Moscato bianco” wine grapes. In another study, Segade (Science Reports, 2017) observed an effect of ozone fumigation on the grape terpene profile at ozone exposure of 30 ul/L over 24 days.

None of the above references allude or infer ozone fumigation as a treatment for smoke taint in fruits or vegetables, a problem now to be discussed.

A recent problem faced by farmed orchards and vineyard regions worldwide that have a Mediterranean climate and are extremely hot summers, rainfall concentrated in the winter, and consequent summer droughts. These conditions are expected to deteriorate in view of increasing climate change. These conditions are conducive to bush fires, either within the orchards and vineyards themselves or in the surrounding bush areas. Fires within vineyards or orchards, or in the surrounding bush can create blankets of smoke that can hang over the neighboring farms for extended periods, resulting in smoke damage to the fruits.

Wines produced from smoke-impacted grapes have undesirable sensory characters, such as smoky, burnt, ashy, or medicinal sensory characteristics, known as smoke taint. The impact of smoke taint on wine quality is particularly acute for red wines. Unlike in most white wines, the fermentation of red grapes includes the grape skins containing must of the smoke compounds directly in the broth. Farmers with smoke taint grapes choose either to not harvest and leave them on the vines or continue to wine production, and choose not to release the produced wine if unsavory sensory characters prevail.

In the later part of 2019, and early 2020, record high temperatures and drought conditions resulted in bush fires impacting wine grape production in Australia. The fires were widespread, affecting fruit production in the states of South Australia, New South Wales, and Victoria. Overall, smoke taint impacted around four percent of the one and a half-million-ton total yearly wine-grape crush, resulting in over one hundred million US dollars of losses. Later in 2020, tires sparked by powerlines set off blazes in Napa, Sonoma, and Mendocino counties in California and the Oregon wine regions, resulting in widespread smoke tainted grapes. Later in October, bush fires ignited in the Dao region of Central Portugal and the Rias Baixas and Galicia wine regions of Northern Spain. According to NOAA, 2020 was the hottest summer on record in the Northern Hemisphere, enabling the bush fire season.

In addition to fires impacting vineyards seasonally in both the northern and southern hemispheres, bush fires occur with increased frequency and are becoming regular events. In addition to the 2020 California fires, wine production was impacted by fires in 2019, 2018, and 2017. In the southern hemisphere in 2017, the farming of highly combustible pine and eucalyptus, combined with midsummer drought, fueled blazes impacting the wine regions of Chile and Argentina. South African wine production in the Stellenbosch region was also significantly impaired in 2017, following fire events in 2016 and 2015. Bush fires causing smoke taint have become a yearly occurrence in the Southern Italy wine regions, recognizing Italy is the largest wine-producing country globally.

The atmospheric burning of biomass contributes to the formation of secondary organic aerosols. Lignin, a polyphenolic polymer, is the primary biomass component in addition to polymeric forms of cellulose and hemicellulose sugars. When burned in the atmosphere, lignin produces extensive methoxyphenol compounds, while the polymeric forms of sugar oxidize to carbon dioxide and water. According to Chen et al, (International Journal of Molecular Science, 2019), the major methoxyphenol compounds of wood smoke are guaiacol, 4-methyl guaiacol, syringol, and creosol. These compounds interact and react with the OH radicals, NO3 radicals, chlorine atoms, and low-levels of ozone in the atmosphere. Studies of atmospheric photochemistry show that syringol and creosol degrade rapidly in air. However, guaiacol and 4-methyl guaiacol do not degrade rapidly. With a boiling point of 204° C., these molecules remain in aerosol form, and are available to absorb on the surfaces of the grapes and vines upon contact. Once on the grape skin, the guaiacols can react with the sugars to form glycoside compounds. The compounds guaiacol and 4-methyl guaiacol, which have not reacted with sugars, are primary agents contributing to smoke taint.

Phenolic compounds also play a large role in the texture, color, taste, and longevity of finished wines. Anthocyanins and tannins are the primary polyphenolic compounds in wine. Anthocyanins are only located in grapes' skins, providing the red/blue/black pigments of wines. Anthocyanins belong to a parent class of molecules called flavonoids, which are short-chain phenolic polymers with molecular weights on the order of 200. Tannins occur in the skins and seeds of grape berries, providing astringency and bitterness to a wine. Tannins are much larger molecules with molecular weights ranging from 500 to over 3000. Tannins serve to stabilize the anthocyanins in wine, contributing to wine longevity. Trans-resveratrol and its derivatives are another class of polyphenolic compounds present in grapes, with reported health-promoting properties.

A way to reduce the impact of these molecules on the quality of grapes has been to treat food with ozone. Ozone is an inorganic molecule with the formula of O₃, produced from passing oxygen across a corona discharge or through activation by ultraviolet radiation. Ozone is rich in electrons and a powerful oxidant reacting readily with molecules that are deficient in electrons including the aromatic polyphenolic compounds found in wine grapes. Ozone degrades rapidly back to oxygen if it does not participate in some other chemistry.

Because ozone is a highly-reactive oxidizing gas, it can directly impair the lungs and respiratory function of humans and animals who breathe it. Inhaled ozone causes inflammation and acute but reversible lung function changes, causing shortness of breath, wheezing, and coughing. OSHA regulates human ozone exposures in terms of maximum concentrations and time exposures. Therefore, engineered systems utilizing ozone must be designed to mitigate potential health impacts by avoiding human contact with the ozonated atmosphere or complying with safe exposure guidelines.

The state-of-the-art in eliminating smoke taint is shown in an academic article by Antolini, et al., (Ozone: Science & Engineering, 2020) who obtained white table grapes, suspended them with a tripod, and smoked them with a grass straw fire. The grapes were subsequently exposed to gaseous ozone in the laboratory at 3 mg/liter (1400 ppm) for four hours. Guaiacol concentration was reduced from 33.9 ug/L to 18.9, and 4-methylguaiacol was reduced from 18.3 ug/L to 13.0. Note that the ozone concentration used in this study was two orders of magnitude higher than presented in the current invention. Other solutions to this problem have aimed to remove the smoke taint after the wine is made, as in US Patent Applications 20200172842, which uses a resin to remove smoke taint from wine, and US Patent Application 20050249851 uses reverse osmosis and filtration media for removal of smoke taint from wine.

The full nature of the advantages of the disclosure will become more evident from the following detailed description.

### BRIEF DESCRIPTION OF THE DRAWINGS

Certain embodiments of the present disclosure will hereinafter be described in detail, by way of example only, with reference to the accompanying drawings, in which:

FIG. 1 is a diagram illustrating a system demonstrating an embodiment of the present invention.

FIG. 2 is a diagram illustrating a system configured to implement the method of the present invention.

FIG. 3 is a diagram showing results from a referenced publishing that indicates consistent decreases in Guaiacol and 4-methyl guaiacol concentrations contributing to smoke taint, and a lack of effect on the polymeric anthocyanin levels from ozone treatment. The original colored version of this figure can be seen in (Modesti, 2021)

### DETAILED DESCRIPTION

In the following paragraphs, embodiments of the present disclosure will be described in detail by way of example with reference to the attached drawings. Throughout this description, the preferred embodiment and examples shown should be considered as exemplars, rather than as limitations on the present disclosure. As used herein, the “present disclosure” refers to any one of the embodiments of the disclosure described herein, and any equivalents. Furthermore, reference to various feature(s) of the “present disclosure” throughout this document does not mean that all claimed embodiments or methods must include the referenced feature(s).

The current invention discloses a system and method for treating smoke taint in fruits and vegetables, in particular smoke taint in wine grapes in order to improve wine quality.

Smoke tainted grapes will have phenolic compounds such as guaiacol or 4-methyl guaiacol, as well as other smoke related molecules, of at least 0.5 ug/kg of the fruit crush that must be reduced with gaseous ozone. The following are chemical structures of some phenolic compounds typically found in wood smoke resulting from the pyrolysis of ligno-cellulose:

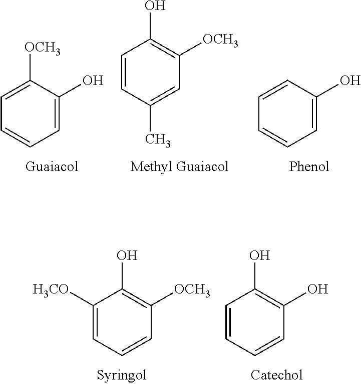

In addition to the above listed volatile phenols, smoke taint and smoke taint markers include the volatile phenols m-cresol, p-cresol, o-cresol, 4-Methylguaiacol, 4-Methyl syringol, 4-Ethylguaiacol, 4-Ethylphenol and the phenolic glycoside compounds Guaiacol rutinoside, Methylguaiacol rutinoside, Syringol gentiobioside, Methylsyringol gentiobioside, Cresol rutinoside, and Phenol rutinoside.

In addition to the above phenolic compounds, other compounds typically found in smoke include aldehydes such as formaldehyde, acetaldehyde, propional, butyraldehyde; ketones such as acetone, and methyl ethyl ketone; benzene and alkylbenzenes such as toluene and ethyl benzenes, and polycyclic aromatic hydrocarbons (PAHs) such as fluorene, phenanthrene and pyrene.

The system and method of the present invention destroy smoke compounds in smoke-tainted grapes at much lower ozone exposures than the prior art, while preserving the anthocyanin levels in grapes. The benefit of the instant invention is that 1) using lower concentrations of ozone in commercial practice will require smaller ozone generation equipment at a reduced cost, 2) the smaller ozone generators will use less energy and have lower power costs, and 3) the lower ozone concentrations mitigate the possibility of harm to humans in the event that safety practices are breached and ozone exposure occurs 4) the short exposure ozone treatments increase system throughput thereby reducing treatment costs.

The method comprises exposing fruits and vegetables in a containerized environment at ozone exposures ranging from 1 ppm-hr to 5000 ppm-hr to destroy common chemicals in wood smoke, more preferentially from exposures ranging from 200 ppm-hr to 500 ppm-hr, and most preferentially from exposures ranging from 30 ppm-hr to 50 ppm-hr. The prior art teaches exposures exceeding 5600 ppm-hr to remove smoke taint from grapes.

The method of the present invention is applicable to fruits and vegetables affected by smoke taint. Particularly, the method is applicable to fruits selected from wine grapes, table grapes, stone fruit such as peaches, nectarines, plums, lychees, mangoes, almonds, apricots, dates and cherries, berries such as strawberries, raspberries, blueberries, blackberries, red currants, white currants, blackcurrants, apples and pears. Treatment to diminish smoke taint is desired due to high consumer preference for smoke-free smell and taste. This method is also applicable to any produce vegetable such as carrots, tomatoes, eggplants, bell peppers, broccoli, and celery.

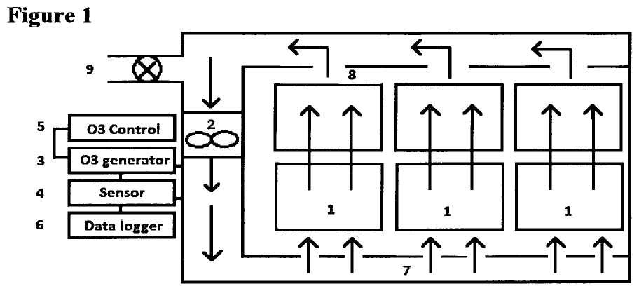

A system of the present invention is a container that is mobile and can be readily transported by ship, train or truck and that applies ozone exposures ranging from 1 ppm-hr to 5000 ppm-hr to destroy common chemicals in wood smoke, more preferentially from exposures ranging from 200 ppm-hr to 500 ppm-hr, and most preferentially from exposures ranging from 30 ppm-hr to 50 ppm-hr. The exposure range between 1 ppm-hr and 5000 ppm-hr can be satisfied, for example, if the container ozone levels are maintained at 1 ppm for 1 hour on the low end, and 10 ppm for 500 hours on the high end. FIG. 1 shows the vertical cross section of a container described herein.

Fruit is harvested and loaded into standard size harvest bins 1. The loaded bins are stacked on top of each other. With the container loaded with fruit, and the container closed. Power is brought to the container and used to energize the system devices. On-board power is used in cases where the container has a power source, such as in refrigerated shipping containers. Air flow is established through the system using an ID fan system 2. Ozone is generated using either UV light system or corona discharge 3. An electrochemical sensor 4 utilizing a porous membrane is exposed to the air ozone mixture and the ozone diffuses across a porous membrane into a cell containing electrolyte and electrodes generating an electrical signal. The signal strength is a measure of the ozone concentration in ppm or ppb on a volume basis. A controller 5 is communicatively coupled with sensor 4 to adjust the current flow to the ozone generator to maintain the required setpoint ozone concentration in the container. A data logger 6 is used to record ozone compositions and control parameters. On embodiment of the control system is the use of wireless control and data-logging through a web-based server platform enabling remote operation. The system is designed to force air and ozone the bottoms of the pallets, from bottom to top. The ductwork in the container through which the air enters 7 and exits the system 8 is placed and sized in order to create a chimney effect driving air flow uniformly in and out of the bins. A suitable power adapter to power accessory ozone generation and control systems in refrigerated shipping containers is described by Dick, P. H., and Saadat, S, et al. in United States Patent Application 20120309215, “Apparatus for Powering an Accessory Device in a Refrigerated Shipping Container”.

A catalyst system can be installed in the external fresh air exchange system 9. The catalyst would facilitate the reduction of any remaining ozone to oxygen in order to mitigate the possibility of human exposure to ozone, for instance when venting to indoor spaces. Catalysts such as platinum or Carulite (a zeolite) are suitable for this purpose. The catalyst system should be heated using electrical resistance in order to prevent water from condensing on the catalyst reducing its efficiency. A refrigeration system can also be deployed into the container if fruit cooling is desired. The container size is sized to accommodate multiple standard size harvest bin stacked on top of each other. The larger the container the greater the ozonation throughput.

The bins and container walls used should be manufactured from materials known to be resistant to ozone. Examples of materials known not to be compatible are non-virgin polypropylene resins, nitrile, nylon, and latex.

Another embodiment of this invention is where the container is a building or cold-storage room. The ozone generation, sensing, control and data logging equipment are installed and operated in order to maintain the ozone concentration inside the room. Such facilities are widely used to fumigate grapes with sulfur dioxide, and water scrubbing is often used to remove treatment gases from the air upon completion of the process. The room is unattended during ozonation.

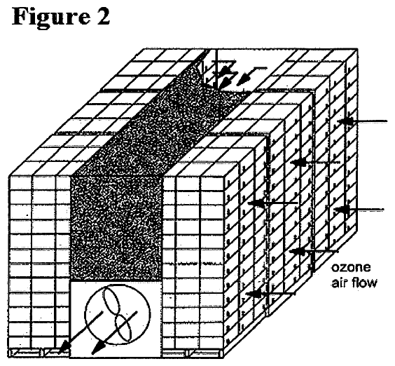

Inside the building or cold room, palletized fruit from the field are stacked in parallel leaving a space between them, and a tarp is placed over top of the system to contain air flow, in order to create a tunnel of forced air flow through the system. A fan system is installer) to draw ozone-containing air though the pallets to ensure uniform treatment as shown in FIG. 2. The fruit is exposed to the required ozone concentration and time as described herein for smoke removal.

Another embodiment of this invention includes bins or storage containers which are perforated to allow a gaseous mixture to flow through the bins or container allowing the ozonated air mixture to contact the fruit or vegetables held within the bin or container.

Another embodiment includes a container holding fruit, and said container is of a cylindrical form and does not need circulating air flow. In this form, the fruit itself is rotated therefore the circular air flow is not needed because the process is stagnant in nature and the fruit is exposed due to its movement inside such container.

It has been found that in these scenarios and embodiments, other than the immediately preceding one, that the air flow around and entering the stagnant containers holding fruit should be preferentially at or above 10 feet per minute (10FPM) to be effective enough to penetrate the fruit held within.

### Example 1

In the aftermath of the September 2020 bush fires in Sonoma and Napa Valley in California, and those in Willamette Valley in Oregon, refrigerated shipping containers with ozone generation, sensing, and control systems were deployed to these regions in attempt to mitigate wine grape smoke taint.

Post-harvest smoke-tainted grapes, and controls, in standard vineyard field harvest bins were loaded into the containers. Ozone generation, sensing, and control capabilities were added into the circulation fan of each container. A high volume of air was forced down and through the slotted channels of the container, and the air forced up through the grape containers. The systems were operated to provide a forced air chimney effect venting at the top of the container to assure uniform flow through the bins.

The grapes were exposed to uniform forced air flow ozone concentrations ranging between three and four ppm for twenty-four hours, and then removed and subjected to chemical testing. Table 1 shows the average results from a winery in Sonoma Valley.

TABLE 1
Impact of Ozonation on Smoke-Tainted Grapes

| | | After 24 hour forced air |
|---|---|---|
| Molecule | Control | ozone treatment |
| Guaiacol (ug/kg) | 2.7 | 1.0 |
| 4-methyl guaiacol (ug/kg) | 0.6 | <0.5 |
| Catechin (mg/L) | 25 | 22 |
| Tannin (mg/L) | 372 | 366 |
| Polymeric Anthocyanins (mg/L) | 24 | 24 |

It has also been shown that this invention can decrease the above mentioned volatile and non-volatile organic compounds, as was reported in MDPII Molecules journal (Modesti, 2021)

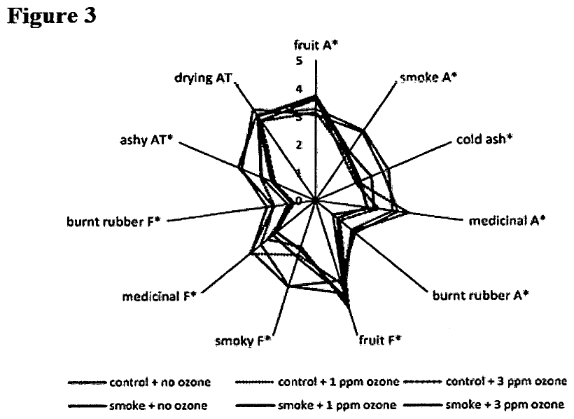

This evidence is supported by FIG. 3 covering the taste of treated wines inside the ozone concentration and time values claimed here within.

### BIBLIOGRAPHY

Antolini, A., Forniti, R., Modesti, M., Bellincontrol, A., Catelli, C., & Mencarelli, F. (2020). First Application of Ozone Postharvest Fumigation to Remove Smoke Taint from Grapes. Ozone Science & Engineering, 1-9.
Bellincontro, A., Catelli, C., Cotarella, R., & Mencarelli, F. (2017). Postharvest ozone fumigation of Petit Verdot grapes to prevent the use of sulfites and to increase anthocyanin in wine. Australian Journal of Grape and Wine Research, 200-2006.
Chen, Z., Sun, Y., Qi, Y., Liu, L., & Zho, Y. (2019). Mechanistic and Kinetic Investigations on the Ozonolysis of Biomass Burning Products: Guaiacol, Syringol, and Cresol. International Journal of Molecular Sciences, 1-14.
Dick, P. H., Cope, D. J., Wang, H., Hoobler, R. J., Weber, M., & Volondin, A. (2008). US Patent No. 2008/0159910 A1.
Dick, P. H., Saadat, S., Hayes, R., Weber, M., & Shannon, M. (2014). U.S. Pat. No. 8,867,187 B2.
Segade, S. R., Vincenzi, S., Giacosa, S., & Rolle, L. (2019). Changes in stilbene compostion during postharvest ozone treatment of “Moscato bianco” winegrapes. Food Research International, 252-257.
Segade, S., Vilanova, M., Giacosa, S. et al. (2017). Ozone Improves the Aromatic Fingerprint of White Grapes. Sci Rep 7, 16301.
Modesti, M.; Szeto, C.; Ristic, R.; Jiang, W.; Culbert, J.; Bindon, K.; Catelli, C.; Mencarelli, F.; Tonutti, P.; Wilkinson, K.
   Potential Mitigation of Smoke Taint in Wines by Post-Harvest Ozone Treatment of Grapes. Molecules 2021, 26, 1798. https://doi.org/10.3390/molecules26061798 Academic Editor: Encarna Gómez-Plaza

1. A method for the treatment of fruits and vegetables to reduce the concentration of smoke taint compounds in said fruits and vegetables, comprising: (i) placing said fruits and vegetables in a containerized environment; (ii) raising ozone concentration levels in said containerized environment to expose said fruits or vegetables to ozone exposures varying from 1 ppm-hr to 5000 ppm-hr.

2. A method according to claim 1, wherein the fruits comprise at least one of: wine grapes, table grapes, peaches, nectarines, plums, lychees, mangoes, almonds, pistachios, apricots, dates and cherries, strawberries, raspberries, blueberries, blackberries, red currants, while currants, blackcurrants, apples and pears.

3. A method according to claim 1, wherein the smoke taint compounds include phenolic compounds selected from at least one of: guaiacol, 4-Methylguaiacol, phenol, syringol, catechol, m-cresol, p-cresol, o-cresol, 4-Methylsyringol, 4-Ethylguaiacol, and 4-Ethylphenol.

4. A method according to claim 1, wherein the smoke taint compounds include phenolic compounds selected from at least one of: Guaiacol rutinoside, Methylguaiacol rutinoside, Syringol gentiobioside, Methylsyringol gentiobioside, Cresol rutinoside, and Phenol rutinoside.

5. A method according to claim 1, wherein the smoke taint compounds include compounds selected from at least one of: formaldehyde, acetaldehyde, propional, butyraldehyde; acetone, methyl ethyl ketone; benzene, toluene, ethyl benzenes, fluorene, phenanthrene and pyrene.

6. A method according to claim 1, wherein the ozone exposure is in the range of 20 to 500 ppm-hr.

7. A method according to claim 1, wherein the ozone exposure is in the range of 30 to 100 ppm-hr.

8. A method according to claim 1, wherein the containerized environment is a mobile container that can be readily transported by ship, train or truck.

9. A method according to claim 1, wherein the containerized environment is a building or cold-storage room.

10. A method according to claim 1, wherein the containerized environment is a rotating drum or cylindrical container.

11. A method according to claim 9, wherein the exposure in the building or cold-storage room is performed using circulating-air fumigation.

12. A system to reduce the concentration of smoke taint compounds in fruits and vegetables, comprising: (i) an enclosed container (ii) an ozone generation system (iii) an ozone detection system and (iv) a fan system to regulate air flow within the container, wherein ozone levels in said container are maintained between 1 ppm and 10 ppm for periods ranging from 1 hour to 500 hours.

13. A system according to claim 12, wherein the ozone detection system is an electrochemical system.

14. A system according to claim 12, wherein the air flow is at or above 10 feet per minute around or entering the container holding fruit as described in claim 1.

15. A system according to claim 12, wherein the container walls are made from non-virgin polypropylene resins, nitrile, nylon, or latex.

16. A system according to claim 12, wherein the container is mobile and transportable by ship, train or truck.

17. A system according to claim 12, wherein the container is a building or cold storage room.

18. A system according to claim 12, wherein the container is a rotating drum or cylindrical container.

19. A system according to claim 12, wherein the fan system uses circulating air fumigation.
